(19) United States
(12) Patent Application Publication
(10) Pub. No.: US 2025/0043038 A1
(43) Pub. Date: Feb. 6, 2025

(54) CATALYST FOR OLEFIN POLYMERIZATION INCLUDING HYBRID CATALYST COMPOSITION AND OLEFIN-BASED POLYMER PREPARED USING THE SAME

(71) Applicant: HANWHA SOLUTIONS CORPORATION, Seoul (KR)

(72) Inventors: Hye Ran PARK, Daejeon (KR); Ui Gap JOUNG, Daejeon (KR); Junho SEO, Daejeon (KR); Munhee LEE, Daejeon (KR); Daegak KIM, Daejeon (KR); Sung Dong KIM, Daejeon (KR); Seongjae LIM, Daejeon (KR); Ahreum KIM, Daejeon (KR); Jeong Hyun PARK, Daejeon (KR)

(73) Assignee: HANWHA SOLUTIONS CORPORATION, Seoul (KR)

(21) Appl. No.: 18/717,190

(22) PCT Filed: Dec. 6, 2022
(86) PCT No.: PCT/KR2022/019675

§ 371 Date: Jun. 6, 2024

(30) Foreign Application Priority Data
Dec. 7, 2021 (KR) 10-2021-0173471

(51) Int. Cl. C08F 4/6592; C08F 4/659; C08F 210/16

(52) U.S. Cl. CPC C08F 4/65927; C08F 4/65908; C08F 4/65912; C08F 4/65916; C08F 4/65925; C08F 210/16

(57) ABSTRACT

Provided are a catalyst for olefin polymerization including a hybrid catalyst composition and an olefin-based polymer prepared therefrom. The hybrid metallocene catalyst allows preparation of an olefin polymer having a broad molecular weight distribution and excellent high-speed processability. In addition, an olefin-based polymer prepared in the presence of the hybrid catalyst has a broad molecular weight distribution and excellent high-speed processability.

### TECHNICAL FIELD

The present invention relates to a catalyst for olefin polymerization including a hybrid catalyst composition, and an olefin-based polymer prepared therefrom. Specifically, the present invention relates to a hybrid metallocene catalyst for olefin polymerization for preparing an olefin-based polymer having a broad molecular weight distribution, and an olefin polymer which is polymerized in the presence of the catalyst, has a broadmolecular weight distribution, and has excellent high-speed processability.

### BACKGROUND ART

Polyolefin-based polymers are used in various ways in real life as materials for shopping bags, greenhouses, fishing nets, cigarette wrappers, ramen bags, yogurt bottles, battery cases, car bumpers, interior materials, shoe soles, washing machines, and the like.

Conventionally, polyolefin-based polymers such as polyethylene, polypropylene, and ethylene α-olefin copolymers and copolymer thereof are prepared by heterogeneous catalysts such as a Zielger-Natta catalyst formed of a titanium compound and an alkyl aluminum compound.

Recently, a method of preparing polyolefin using a metallocene catalyst which is a homogeneous catalyst having very high catalytic activity has been studied. A metallocene catalyst is a compound in which a ligand such as cyclopentadienyl, indenyl, or cycloheptadienyl is coordinated to a transition metal or a transition metal halogen compound, and has a sandwich structure as a basic form. Herein, it has various molecular structures depending on a ligand form and the type of center metal.

A Ziegler-Natta catalyst which is a heterogeneous catalyst has an active site having heterogeneous properties, since a metal component as the active site is dispersed on an inert solid surface; however, the metallocene catalyst is known as a single-site catalyst having identical polymerization properties in all active sites, since it is one compound having a certain structure.

The metallocene catalyst as such is easily used for copolymerization and may adjust a stereostructure of a polymer depending on catalyst symmetry, and a polymer prepared therefrom has a narrow molecular weight distribution and a uniform comonomer distribution.

However, a polymer prepared by the metallocene catalyst has excellent mechanical strength, but low processability, due to the narrow molecular weight distribution. In order to solve the problem, there are various methods, such as changing a molecular structure of a polymer or broadening a molecular weight distribution. For example, in U.S. Pat. No. 5,272,236, processability of a polymer was improved using a catalyst in which a long chain branch (LCB) is introduced as a side branch to a main chain of a polymer, but a supported catalyst had low activity.

In order to solve the problem of the single metallocene catalyst and more conveniently develop a catalyst having excellent activity and improved processability, a method of hybrid-supporting metallocene catalysts (heterogeneous metallocene catalysts) having different properties from each other was suggested. For example, U.S. Pat. Nos. 4,935,474, 6,828,394, and 6,894,128, Korean Patent No. 1437509, and U.S. Pat. No. 6,841,631 disclose a method of preparing polyolefin having a bimodal molecular weight distribution using catalysts having different reactivities to comonomers.

However, polyolefin having a bimodal molecular weight distribution does not necessarily have excellent processability in a high speed area.

Therefore, there is a need for a metallocene catalyst capable of preparing an olefin-based polymer with a broad molecular weight distribution and excellent high-speed processability.

### DISCLOSURE

### Technical Problem

An object of the present invention is to provide a hybrid metallocene catalyst capable of preparing an olefin-based polymer having a broad molecular weight distribution and excellent high-speed processability.

Another object of the present invention is to provide an olefin-based polymer which is prepared in the presence of the above catalyst, and has a broad molecular weight distribution and excellent high-speed processability.

### Technical Solution

According to one embodiment of the present invention, a hybrid metallocene catalyst includes: (a) at least one first transition metal compound selected from a transition metal compound represented by the following Chemical Formula 1 and a transition metal compound represented by the following Chemical Formula 2; (b) at least one second transition metal compound selected from a transition metal compound represented by the following Chemical Formula 3; (c) at least one third transition metal compound selected from a transition metal compound represented by the following Chemical Formula 4, a transition metal compound represented by the following Chemical Formula 5a, and a transition metal compound represented by the following Chemical Formula 5b; and (d) a cocatalyst compound; wherein an olefin-based polymer prepared in the presence of the catalyst has a processability index represented by the following Equation 1 of 0 to 4.5, preferably 0 to 4.0:

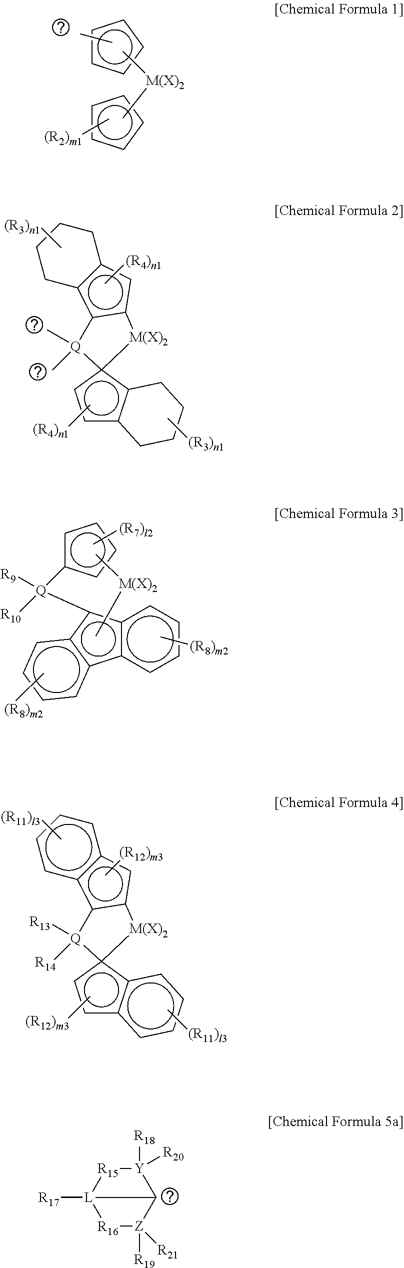

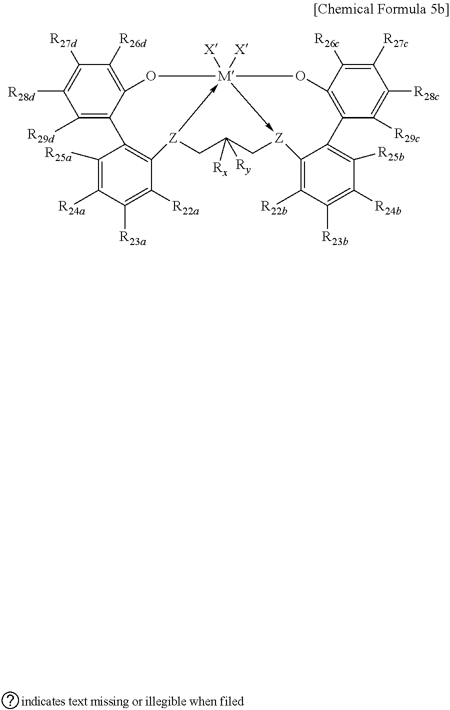

$$Processability index = [ ( HMW \% ) \times ( HMW Mw ) - ( LMW \% ) \times ( LMW Mw ) ] \times ( total PDI ) / ( total Mw ) \qquad [ Equation 1 ]$$

wherein l1 and m1 are independently of each other an integer of 0 to 5,
l2, l3, m2, and n1 are independently of one another an integer of 0 to 4;
m3 and o1 are independently of each other an integer of 0 to 2,
p is an oxidation state of M, and is +3, +4, or +5,
q is a formal charge of a YZL ligand, and is 0, −1, −2, or −3,
M is independently of each other titanium (Ti), zirconium (Zr), or hafnium (Hf),
M′ is titanium, zirconium, or hafnium, and is in a formal oxidation state of +2, +3, or +4, respectively,
X is independently of each other a halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido,
X′ is independently of each other alkyl,
Q is independently of each other carbon (C), silicon (Si), germanium (Ge), or tin (Sn),
Q′ is an anionic leaving group and is independently of each other hydrogen, a substituted or unsubstituted C₁₋₄₀ hydrocarbon group, a substituted or unsubstituted C₁₋₄₀ heterohydrocarbon group, a heteroatom, or a halogen,
L is a Group 15 or Group 16 element, and preferably nitrogen,
Y is a Group 15 element, preferably nitrogen or phosphorus, and more preferably nitrogen,
Z is a Group 15 element, preferably nitrogen or phosphorus, and more preferably nitrogen,
Z′ is independently of each other —O—, —S—, —N(C₁₋₄₀ hydrocarbon group)-, or —P(C₁₋₄₀ hydrocarbon group)-,
R₁ to R₄, R₇, R₈, R₁₁, and R₁₂ are independently of one another substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, or substituted or unsubstituted C₁₋₂₀ silyl, but these may or may not be independently of each other connected to an adjacent group to form a substituted or unsubstituted, saturated or unsaturated C₄₋₂₀ ring,
R₅, R₆, R₉, R₁₀, R₁₃, and R₁₄ are independently of each other substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, or substituted or unsubstituted C₁₋₂₀ silyl, but R₅ and R₆, R₉ and R₁₀, and R₁₃ and R₁₄ may or may not be independently of one another connected to each other to form a substituted or unsubstituted, saturated or unsaturated C₂₋₂₀ ring,
R₁₅ and R₁₆ are independently of each other a C₁₋₂₀ hydrocarbon group or a heteroatom-containing group, in which the heteroatom is silicon, germanium, tin, lead, or phosphorus, or R₁₅ and R₁₆ may be connected to each other,
R₁₇ does not exist, or is hydrogen, C₁₋₂₀ alkyl, a halogen, or a heteroatom-containing group,
R₁₈ and R₁₉ are independently of each other an alkyl group, an aryl group, a substituted aryl group, a cyclic alkyl group, a substituted cyclic alkyl group, or a polycyclic system,
R₂₀ and R₂₁ independently of each other do not exist, or may be hydrogen, an alkyl group, a halogen, a heteroatom, a hydrocarbon group, or a heteroatom-containing group,
Rₓ and R_{y} are independently of each other a substituted or unsubstituted C₁₋₄₀ hydrocarbon group, a substituted or unsubstituted C₁₋₄₀ heterohydrocarbon group, a halogen, or hydrogen,
R₂₂ₐ, R₂₃ₐ, R₂₄ₐ, R₂₅ₐ, R_{22b}, R_{23b}, R_{24b}, R_{25b}, R_{26c}, R_{27c}, R_{28c}, R_{29c}, R_{26d}, R_{27d}, R_{28d}, and R_{29d} are independently of one another a substituted or unsubstituted C₁₋₄₀ hydrocarbon group, a substituted or unsubstituted C₁₋₄₀ heterohydrocarbon group, —Si(Rₑ)₃, —OSi(Rₑ)₃, —Ge(Rₑ)₃, —P(Rₑ)₂, —N(Rₑ)₂, —ORₑ, —SRₑ, —NO₂, —CN, —CF₃, —OCF₃, —S(O)Rₑ, —S(O)₂Rₑ, —N═C(Rₑ)₂, —OC(O) Rₑ, —C(O)ORₑ, —N(R)C(O)Rₑ, —C(O)N(Rₑ)₂, a halogen, and hydrogen, in which Rₑ is independently of each other a substituted or unsubstituted C₁₋₃₀ hydrocarbon group or a substituted or unsubstituted C₁₋₃₀ heterohydrocarbon group, but two or more of R₂₂ₐ, R₂₃ₐ, R₂₄ₐ, R₂₅ₐ, R_{22b}, R_{23b}, R_{24b}, R_{25b}, R_{26c}, R_{27c}, R_{28c}, R_{29c}, R_{26d}, R_{27d}, R_{28d}, and R_{29d} may or may not form one or more cyclic structures, and
HMW % is area % of a high molecular weight polymer in a polymer, LMW % is area % of a low molecular weight polymer in a polymer, HMW Mw is a weight average molecular weight of a high molecular weight polymer in a polymer and is 50,000 to 600,000 g/mol; LMW Mw is a weight average molecular weight of a low molecular weight polymer in a polymer and is 5,000 to 30,000 g/mol; total PDI is a molecular weight distribution (Mn/Mw) of a polymer; and total Mw is a weight average molecular weight of a polymer, when measured with gel permeation chromatography (GPC).

In a specific example of the present invention, the transition metal compound of Chemical Formula 1 may be at least one of transition metal compounds represented by the following Chemical Formulae 1-1 to 1-8, and the transition metal compound of Chemical Formula 2 may be a transition metal compound represented by the following Chemical Formula 2-1:

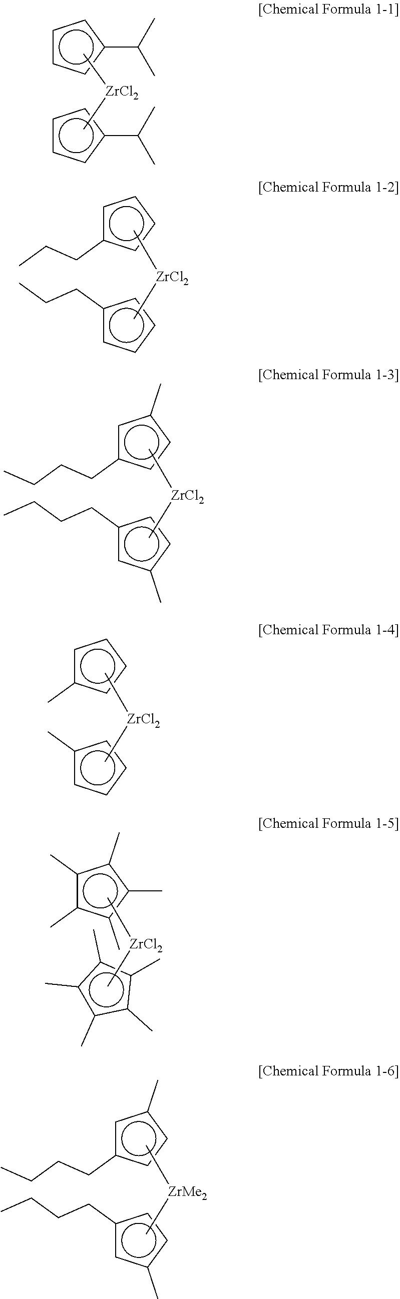

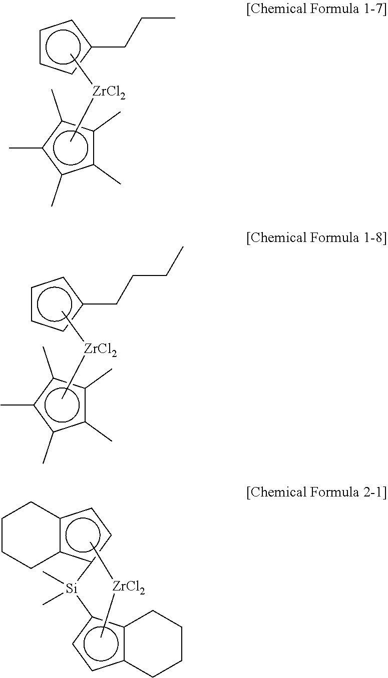

wherein Me is methyl.

In a specific example of the present invention, the transition metal compound of Chemical Formula 3 may be at least one of transition metal compounds represented by the

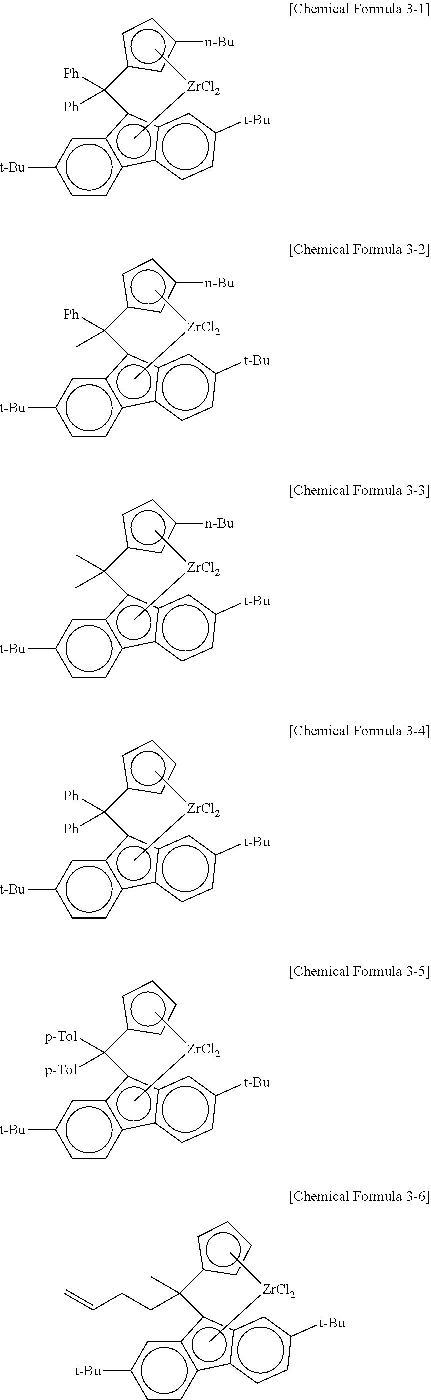

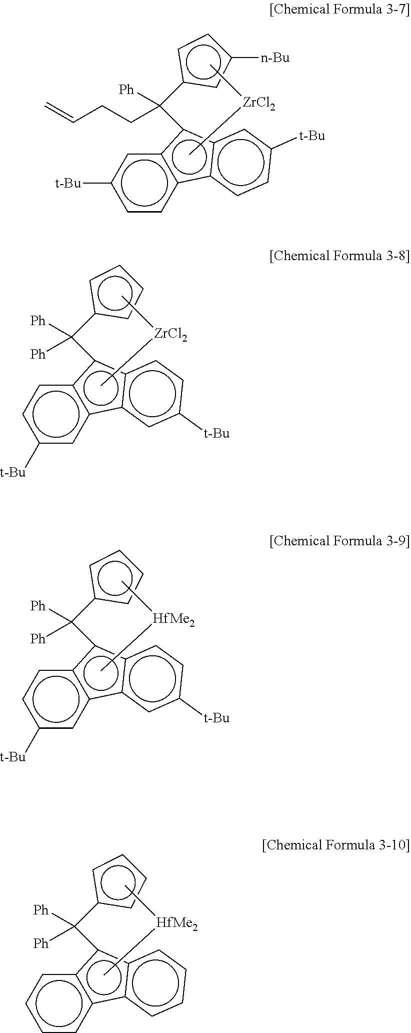

wherein Me is methyl, n-Bu is n-butyl, t-Bu is t-butyl, Ph is phenyl, and p-Tol is p-tolyl.

In a specific example of the present invention, the transition metal compound of Chemical Formula 4 may be at least one of transition metal compounds represented by the following Chemical Formulae 4-1 and 4-2, the transition metal compound of Chemical Formula 5 may be at least one of transition metal compounds represented by the following Chemical Formulae 5-1 to 5-4, and the compound of Chemical Formula 5b may be at least one of transition metal compounds represented by the following Chemical Formulae 5-5 and 5-6:

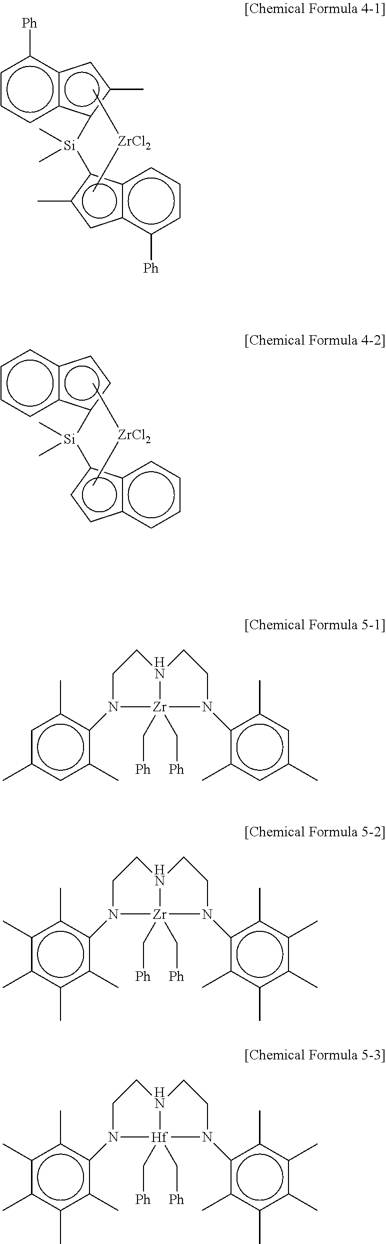

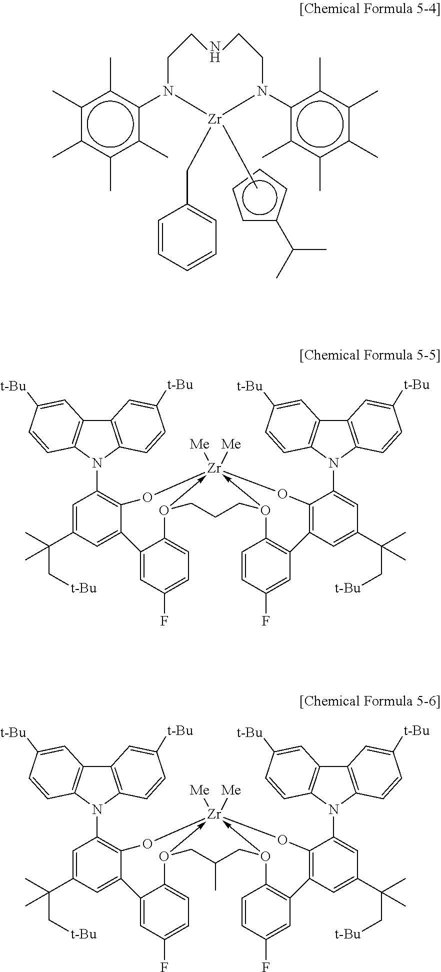

wherein Me is methyl, t-Bu is t-butyl, and Ph is phenyl.

In a specific example of the present invention, the cocatalyst compound may include at least one selected from the group consisting of a compound represented by the following Chemical Formula 6, a compound represented by the following Chemical Formula 7, and a compound represented by Chemical Formula 8:

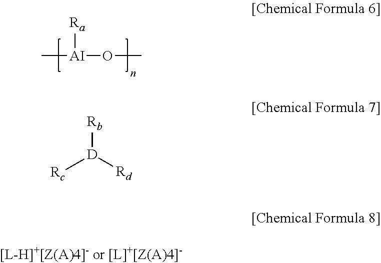

wherein n is an integer of 2 or more, and Rₐ is a halogen atom, a hydrocarbon group having 1 to 20 carbon atoms, or a hydrocarbon group having 1 to 20 carbon atoms substituted by a halogen,
D is aluminum (Al) or boron (B), and R_{b}, R_{c}, and R_{d} are independently of one another a halogen atom, a hydrocarbon group having 1 to 20 carbon atoms, a hydrocarbon group having 1 to 20 carbon atoms substituted by a halogen, or an alkoxy group having 1 to 20 carbon atoms, and L is a neutral or cationic Lewis base, [L-H]⁺ and [L]⁺ are a Bronsted acid, Z is a Group 13 element, and A is independently of each other a substituted or unsubstituted aryl group having 6 to 20 carbon atoms or a substituted or unsubstituted alkyl group having 1 to 20 carbon atoms.

In a preferred specific example of the present invention, the compound represented by Chemical Formula 6 may be at least one selected from the group consisting of methylaluminoxane, ethylaluminoxane, isobutylaluminoxane, and butylaluminoxane.

In a preferred specific example of the present invention, the compound represented by Chemical Formula 7 may be at least one selected from the group consisting of trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, and tributylboron.

In a preferred specific example of the present invention, the compound represented by Chemical Formula 8 may be at least one selected from the group consisting of triethylammonium tetraphenylboron, tributylammonium tetraphenylboron, trimethylammonium tetraphenylboron, tripropylammonium tetraphenylboron, trimethylammonium tetra(p-tolyl)boron, trimethylammonium tetra(o,p-dimethylphenyl)boron, tributylammonium tetra(p-trifluoromethylphenyl)boron, trimethylammonium tetra(p-trifluoromethylphenyl)boron, tributylammonium tetrapentafluorophenylboron, N,N-diethylanilinium tetraphenylboron, N,N-diethylanilinium tetrapentafluorophenylboron, diethylammonium tetrapentafluorophenylboron, triphenylphosphonium tetraphenylboron, trimethylphosphonium tetraphenylboron, triethylammonium tetraphenylaluminum, tributylammonium tetraphenylaluminum, trimethylammonium tetraphenylaluminum, tripropylammonium tetraphenylaluminum, trimethylammonium tetra(p-tolyl)aluminum, tripropylammonium tetra(p-tolyl)aluminum, triethylammonium tetra(o,p-dimethylphenyl)aluminum, tributylammonium tetra(p-trifluoromethylphenyl)aluminum, trimethylammonium tetra(p-trifluoromethylphenyl)aluminum, tributylammonium tetrapentafluorophenylaluminum, N,N-diethylanilinium tetraphenylaluminum, N,N-diethylanilinium tetrapentafluorophenylaluminum, diethylammonium tetrapentatetraphenylaluminum, triphenylphosphonium tetraphenylaluminum, trimethylphosphonium tetraphenylaluminum, tripropylammonium tetra(p-tolyl) boron, triethylammonium tetra(o,p-dimethylphenyl)boron, triphenylcarbonium tetra(p-trifluoromethylphenyl)boron, and triphenylcarbonium tetrapentafluorophenylboron.

In a specific example, the hybrid metallocene catalyst for olefin polymerization may further include a carrier which supports the hybrid transition metal compound, the cocatalyst compound, or both.

In a specific example of the present invention, the carrier may include at least one selected from the group consisting of silica, alumina, and magnesia.

Herein, a total amount of the hybrid transition metal compound supported on the carrier may be 0.001 to 1 mmol based on 1 g of the carrier, and a total amount of the cocatalyst compound supported on the carrier may be 2 to 15 mmol based on 1 g of the carrier.

In another general aspect, an olefin-based polymer which is polymerized in the presence of the hybrid metallocene catalyst for olefin polymerization, and has a density of 0.940 to 0.960 g/cm³, a melt index (I_{2.16}) measured with a load of 2.16 kg at 190° C. of 0.02 to 2.0 g/10 min, a ratio (melt flow ratio; MFR) between a melt index (I_{21.6}) measured with a load of 21.6 kg and a melt index (I_{2.16}) measured with a load of 2.16 kg at 190° C. of 30 to 200, and a processability index represented by the following Equation 1 of 0 to 4.5, preferably 0 to 4.0 is provided:

$$Processability index = [ ( HMW \% ) \times ( HMW Mw ) - ( LMW \% ) \times ( LMW Mw ) ] \times ( total PDI ) / ( total Mw ) \qquad [ Equation 1 ]$$

wherein HMW %, LMW %, HMW Mw, LMW Mw, total PDI, and total Mw are as defined for the above hybrid metallocene catalyst.

In a specific example of the present invention, in the olefin-based polymer, an area of a low molecular weight polymer having a weight average molecular weight of 5,000 to 30,000 g/mol may be 40 to 85%, and an area of a high molecular weight polymer having a weight average molecular weight of 50,000 to 600,000 g/mol may be 15 to 60%, when measured with GPC.

In a specific example of the present invention, the olefin-based polymer may have a shear rate as defined in the following Equation 2 of 1,750 sec-1 or more, preferably 2,0000 sec-1 or more, when measured with a capillary rheometer:

$${\dot{γ}}_{ap} = \frac{4 V}{π {R}^{3}} \qquad [ Equation 2 ]$$

wherein \dot{Y}ₐᵥ is an apparent shear rate (sec⁻¹), V is a volume flow (m³/sec) produced by a piston, and R is a radius (mm) of a round hole capillary.

### Advantageous Effects

The hybrid metallocene catalyst according to an exemplary embodiment of the present invention allows preparation of an olefin-based polymer having a broad molecular weight distribution and excellent high-speed processability. In addition, an olefin-based polymer prepared in the presence of the catalyst has a broad molecular weight distribution and excellent high-speed processability.

### DESCRIPTION OF DRAWINGS

The above and other objects, features and advantages of the present invention will become apparent from the following description of preferred embodiments given in conjunction with the accompanying drawings, in which:

FIGS. 1 to 7 are GPC graphs of olefin-based polymers of the examples, the comparative examples, and the control examples of the present invention, respectively.

### BEST MODE

Hereinafter, the present invention will be described in more detail.

### Hybrid Metallocene Catalyst for Olefin Polymerization

According to an exemplary embodiment of the present invention, a hybrid metallocene catalyst for olefin polymerization including: (a) at least one first transition metal compounds selected from transition metal compounds represented by the following Chemical Formula 1 and transition metal compounds represented by the following Chemical Formula 2; (b) at least one second transition metal compound selected from transition metal compounds represented by the following Chemical Formula 3; (c) at least one third transition metal compound selected from transition metal compounds represented by the following Chemical Formula 4, transition metal compounds represented by the following Chemical Formula 5a, and transition metal compounds represented by the following Chemical Formula 5b; and (d) a cocatalyst compound; is provided:

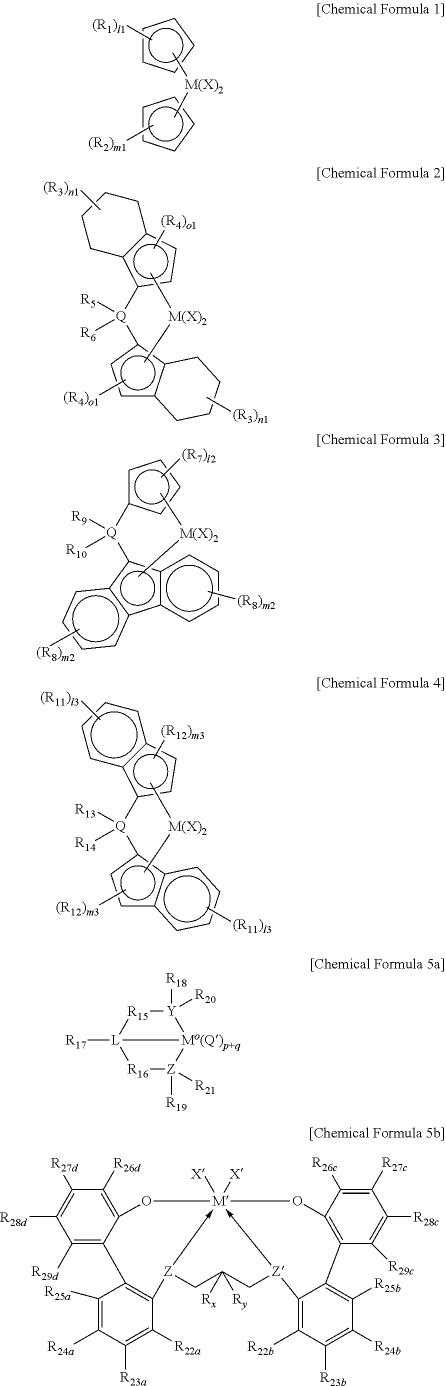

wherein l1 and m1 are independently of each other an integer of 0 to 5. Preferably, l1 is 1, and m1 is independently of each other an integer of 1 to 5,
l2, l3, m2, and n1 are independently of one another an integer of 0 to 4. Preferably, 12, 13, and m2 are 1, respectively, and each n1 is 0.
m3 and o1 are independently of each other an integer of 0 to 2. Preferably, each m3 is 1 and each o1 is 0.
P is an oxidation state of M, and is +3, +4, or +5.
q is a formal charge of a YZL ligand, and is 0, −1, −2, or −3.
M is a Group 4 transition metal of a periodic table of elements. Specifically, M may be titanium (Ti), zirconium (Zr), or hafnium (Hf), more specifically zirconium or hafnium.
M′ is titanium, zirconium, or hafnium, and is in a formal oxidation state of +2, +3, or +4, respectively. Specifically, M′ may be zirconium or hafnium.
X is independently of each other a halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido. Specifically, X may be independently of each other a halogen or C₁₋₂₀ alkyl, more specifically chlorine (Cl) or methyl.
X′ is independently of each other alkyl. Specifically, X′ may be independently of each other methyl.
Q is independently of each other carbon (C), silicon (Si), germanium (Ge), or tin (Sn). Specifically, Q may be independently of each other carbon (C) or silicon (Si).
Q′ is an anionic leaving group and is independently of each other hydrogen, a substituted or unsubstituted C₁₋₄₀ hydrocarbon group, a substituted or unsubstituted C₁₋₄₀ heterohydrocarbon group, a heteroatom, or a halogen.

Specifically, Q′ may be a linear or branched alkyl group, an alkeny group, an alkynyl group, a cycloalkyl group, an aryl group, an alkylaryl group, an arylalkyl group, an acyl group, an aroyl group, an alkoxy group, an aryloxy group, an alkylthio group, a dialkylamino group, an alkoxycarbonyl group, an aryloxycarbonyl group, a carbamoyl group, an alkyl- or dialkyl-carbamoyl group, an acyloxy group, an acylamino group, an aroylamino group, a linear, branched, or cyclic alkylene group, or a combination thereof.
L is a Group 15 or Group 16 element, and preferably nitrogen.
Y is a Group 15 element, preferably nitrogen or phosphorus, and more preferably nitrogen.
Z is a Group 15 element, preferably nitrogen or phosphorus, and more preferably nitrogen.
Z′ is independently of each other —O—, —S—, —N(C₁₋₄₀ hydrocarbon group)- or —P(C₁₋₄₀ hydrocarbon group)-. Specifically, Z′ may be independently of each other —O—.
R₁ to R₄, R₇, R₈, R₁₁, and R₁₂ are independently of one another substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, or substituted or unsubstituted C₁₋₂₀ silyl, but these may or may not be independently of each other connected to an adjacent group to form a substituted or unsubstituted, saturated or unsaturated C₄₋₂₀ ring. Specifically, R₁ to R₄, R₇, R₈, R₁₁, R₁₂ may be independently of one another substituted or unsubstituted C₁₋₂₀ alkyl or substituted or unsubstituted C₆₋₂₀ aryl.
R₅, R₆, R₉, R₁₀, R₁₃, and R₁₄ are independently of one another substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, or substituted or unsubstituted C₁₋₂₀ silyl, but R₅ and R₆, R₉ and R₁₀, R₁₃ and R₁₄ may or may not be independently of one another connected to each other to form a substituted or unsubstituted, saturated or unsaturated C₂₋₂₀ ring. Specifically, R₅, R₆, R₉, R₁₀, R₁₃, and R₁₄ may be independently of one another substituted or unsubstituted C₁₋₂₀ alkyl, substituted or unsubstituted C₂₋₂₀ alkenyl, or substituted or unsubstituted C₆₋₂₀ aryl.
R₁₅ and R₁₆ are independently of each other a C₁₋₂₀ hydrocarbon group or a heteroatom-containing group, in which the heteroatom is silicon, germanium, tin, lead, or phosphorus, or R₁₅ and R₁₆ may be connected to each other. Specifically, R₁₅ and R₁₆ may be independently of each other a C₁₋₆ hydrocarbon group.
R₁₇ does not exist, or is hydrogen, C₁₋₂₀ alkyl, a halogen, or a heteroatom-containing group. Specifically, R₁₇ may be hydrogen or methyl.
R₁₈ and R₁₉ are independently of each other an alkyl group, an aryl group, a substituted aryl group, a cyclic alkyl group, a substituted cyclic alkyl group, or a polycyclic system. Specifically, R₁₈ and R₁₉ may be independently of each other a substituted aryl group.
R₂₀ and R₂₁ independently of each other do not exist, or may be hydrogen, an alkyl group, a halogen, a heteroatom, a hydrocarbon group, or a heteroatom-containing group.
Rₓ and R_{y} are independently of each other a substituted or unsubstituted C₁₋₄₀ hydrocarbon group, a substituted or unsubstituted C₁₋₄₀ heterohydrocarbon group, a halogen, or hydrogen. Rₓ and R_{y} may be independently of each other methyl or hydrogen.
R₂₂ₐ, R₂₃ₐ, R₂₄ₐ, R₂₅ₐ, R_{22b}, R_{23b}, R_{24b}, R_{25b}, R_{26c}, R_{27c}, R_{28c}, R_{29c}, R_{26d}, R_{27d}, R_{28d}, and R_{29d} are independently of one another a substituted or unsubstituted C₁₋₄₀ hydrocarbon group, a substituted or unsubstituted C₁₋₄₀ heterohydrocarbon group, —Si(Rₑ)₃, —OSi(Rₑ)₃, —Ge(Rₑ)₃, —P(Rₑ)₂, —N(Rₑ)₂, —ORₑ, —SRₑ, —NO₂, —CN, —CF₃, —OCF₃, —S(O) Rₑ, —S(O)₂Rₑ, —N═C(Rₑ)₂, —OC(O) Rₑ, —C(O)ORₑ, —N(R)C(O)Rₑ, —C(O)N(Rₑ)₂, a halogen, and hydrogen, in which Rₑ is independently of each other a substituted or unsubstituted C₁₋₃₀ hydrocarbon group or a substituted or unsubstituted C₁₋₃₀ heterohydrocarbon group, but two or more of R₂₂ₐ, R₂₃ₐ, R₂₄ₐ, R₂₅ₐ, R_{22b}, R_{23b}, R_{24b}, R_{25b}, R_{26c}, R_{27c}, R_{28c}, R_{29c}, R_{26d}, R_{27d}, R_{28d}, and R_{29d} may or may not form one or more cyclic structures.

In the hybrid metallocene catalyst for olefin polymerization according to an exemplary embodiment of the present invention, contents of the first transition metal compound, the second transition metal compound, and the third transition metal compound may be determined depending on activity of each catalyst. Preferably, each of the first transition metal compound, the second transition metal compound, and the third transition metal compound may be contained at 10 wt % or more, based on the total amount of the transition metal compound in the hybrid metallocene catalyst for olefin polymerization.

The olefin-based polymer prepared in the presence of the hybrid metallocene catalyst according to an exemplary embodiment of the present invention may have a processability index represented by the following Equation 1 of 0 to 4.5, preferably 0 to 4.0:

$$Processability index = [ ( HMW \% ) \times ( HMW Mw ) - ( LMW \% ) \times ( LMW Mw ) ] \times ( total PDI ) / ( total Mw ) \qquad [ Equation 1 ]$$

wherein HMW % is area % of a high molecular weight polymer in a polymer, LMW % is area % of a low molecular weight polymer in a polymer, HMW Mw is a weight average molecular weight of a high molecular weight polymer in a polymer and is 50,000 to 600,000 g/mol; LMW Mw is a weight average molecular weight of a low molecular weight polymer in a polymer and is 5,000 to 30,000 g/mol; total PDI is a molecular weight distribution (Mn/Mw) of a polymer; and total Mw is a weight average molecular weight of a polymer, when measured with gel permeation chromatography (GPC).

The processability index was derived as a measure indicating a high-speed processability of an olefin-based polymer prepared from the hybrid metallocene catalyst. In order to develop a catalyst having improved processability, a method of using a hybrid metallocene catalyst has been suggested, but not all polyolefins prepared therefrom have excellent processability in a high-speed area. However, the present inventors confirmed that as the processability index value is smaller, the high-speed processability of the olefin-based polymer is better. That is, as seen from Equation 1, when the content ranges of the high molecular weight polymer and the low molecular weight polymer in the olefin-based polymer are appropriate, the olefin-based polymer may have a processability index value belonging to the range of the present invention (that is, 0 to 4.5, preferably 0 to 4.0). In this case, the high-speed processability of the olefin-based polymer may be excellent.

In a specific example of the present invention, the transition metal compound of Chemical Formula 1 may be at least one of transition metal compounds represented by the following Chemical Formulae 1-1 to 1-8, and the transition metal compound of Chemical Formula 2 may be a transition metal compound represented by the following Chemical Formula 2-1:

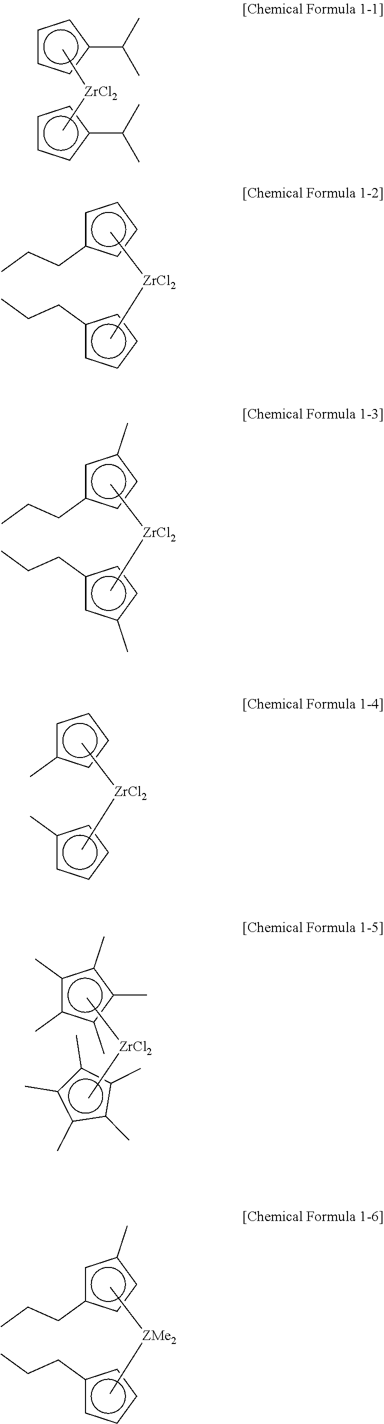

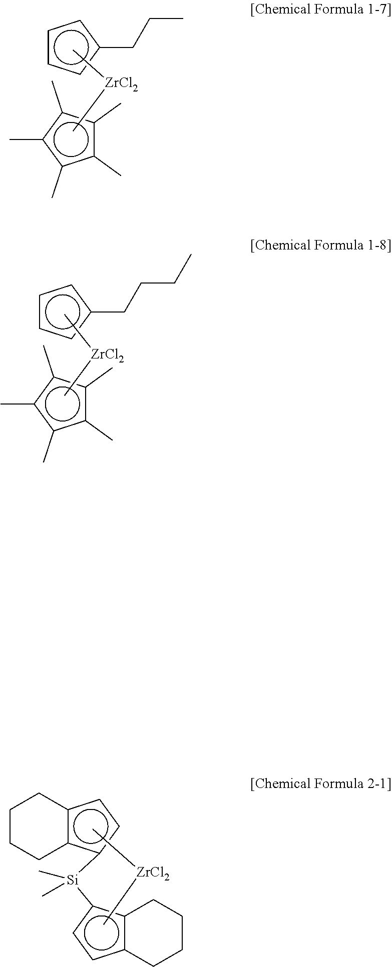

wherein Me is methyl.

In a specific example of the present invention, the transition metal compound of Chemical Formula 3 may be at least one of transition metal compounds represented by the

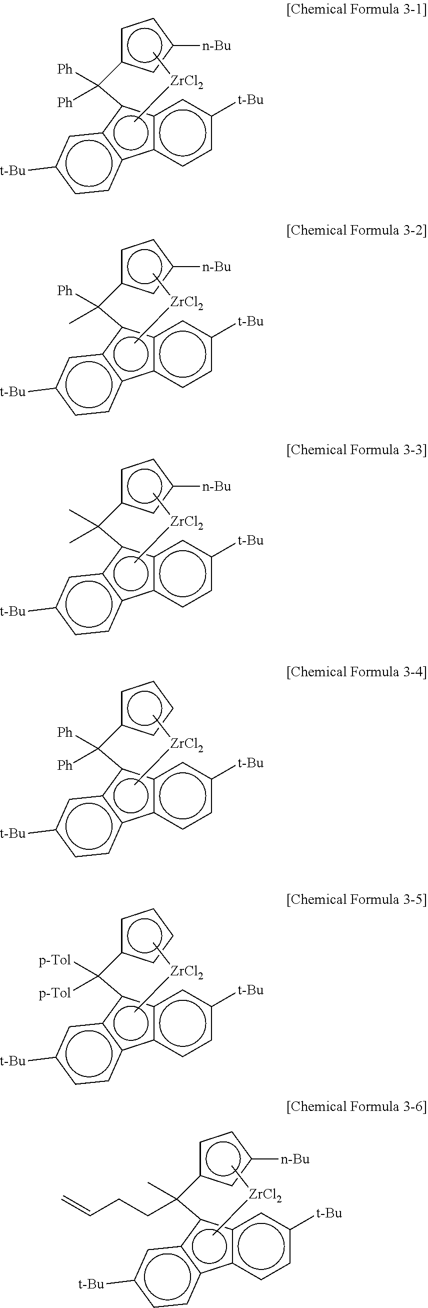

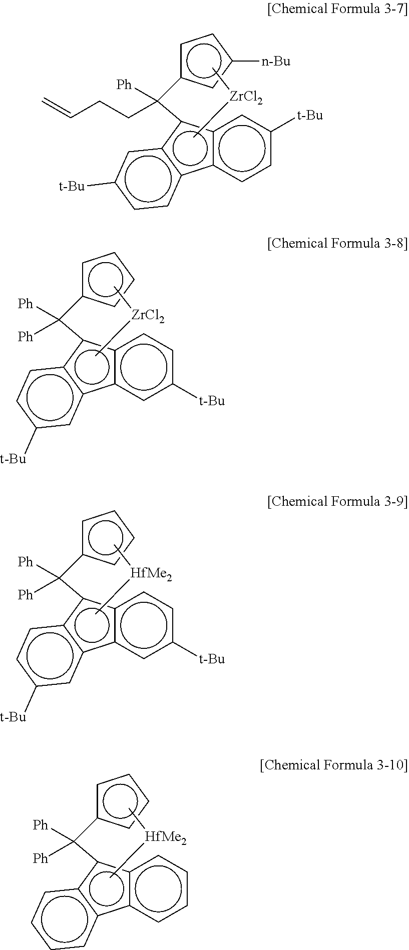

wherein Me is methyl, n-Bu is n-butyl, t-Bu is t-butyl, Ph is phenyl, and p-Tol is p-tolyl.

In a specific example of the present invention, the transition metal compound of Chemical Formula 4 may be at least one of transition metal compounds represented by the following Chemical Formulae 4-1 and 4-2, the transition metal compound of Chemical Formula 5 may be at least one of transition metal compounds represented by the following Chemical Formulae 5-1 to 5-4, and the compound of Chemical Formula 5b may be at least one of transition metal compounds represented by the following Chemical Formulae 5-5 and 5-6:

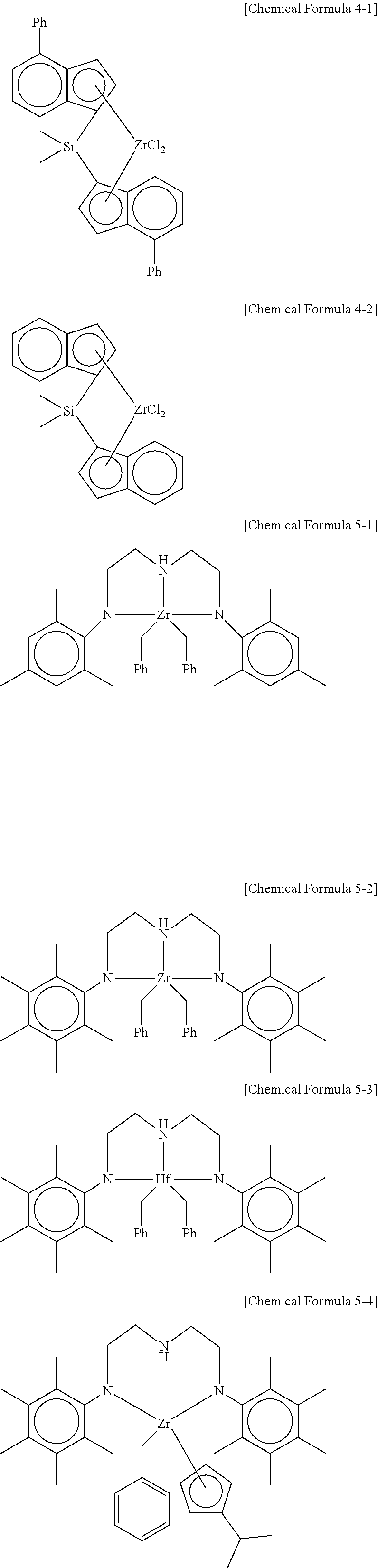

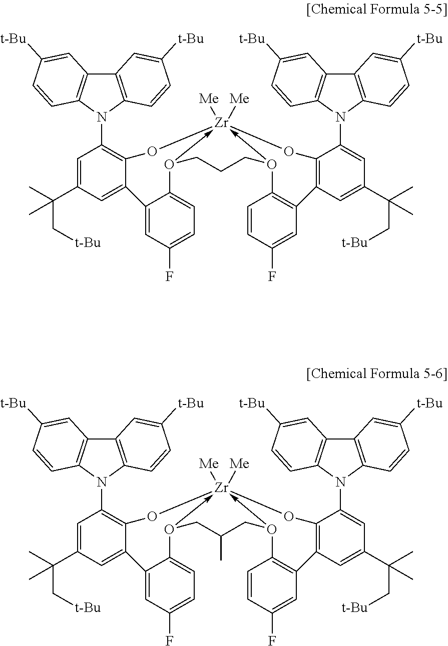

wherein Me is methyl, t-Bu is t-butyl, and Ph is phenyl.

In a specific example of the present invention, the cocatalyst compound may include at least one selected from the group consisting of a compound represented by the following Chemical Formula 6, a compound represented by the following Chemical Formula 7, and a compound represented by Chemical Formula 8:

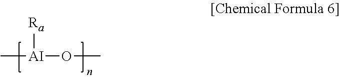

wherein n is an integer of 2 or more, and Rₐ is a halogen atom, a hydrocarbon having 1 to 20 carbon atoms, or a hydrocarbon having 1 to 20 carbon atoms substituted by a halogen. Specifically, Rₐ may be methyl, ethyl, n-butyl, or isobutyl.

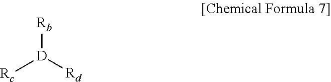

D is aluminum (Al) or boron (B), and R_{b}, R_{c}, and R_{d} are independently of one another a halogen atom, a hydrocarbon group having 1 to 20 carbon atoms, a hydrocarbon group having 1 to 20 carbon atoms substituted by a halogen, or an alkoxy group having 1 to 20 carbon atoms. Specifically, when D is aluminum (Al), R_{b}, R_{c}, and R_{d} may be independently of one another methyl or isobutyl, and when D is boron (B), R_{b}, R_{c}, and R_{d} may be pentafluorophenyl, respectively.

[L-H]⁺[Z(A)₄]⁻ or[L]⁺[Z(A)₄]⁻ [Chemical Formula 8]

L is a neutral or cationic Lewis base, [L-H]⁺ and [L]⁺ are a Bronsted acid, Z is a Group 13 element, and A is independently of each other a substituted or unsubstituted aryl group having 6 to 20 carbon atoms or a substituted or unsubstituted alkyl group having 1 to 20 carbon atoms. Specifically, [L-H]⁺ may be dimethylanilinium cation, [Z(A)₄]⁻ may be [B(C₆F₅)₄]⁻, and [L]⁺ may be [(C₆H₅)₃C]⁺.

An example of the compound represented by Chemical Formula 6 may include methylaluminoxane, ethylaluminoxane, isobutylaluminoxane, butylaluminoxane, and the like, and is preferably methylaluminoxane, but is not limited thereto.

An example of the compound represented by Chemical Formula 7 includes trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, tributylboron, and the like, and is preferably trimethylaluminum, triethylaluminum, and triisobutylaluminum, but is not limited thereto.

An example of the compound represented by Chemical Formula 8 may include triethylammonium tetraphenylboron, tributylammonium tetraphenylboron, trimethylammonium tetraphenylboron, tripropylammonium tetraphenylboron, trimethylammonium tetra(p-tolyl)boron, trimethylammonium tetra(o,p-dimethylphenyl)boron, tributylammonium tetra(p-trifluoromethylphenyl)boron, trimethylammonium tetra(p-trifluoromethylphenyl)boron, tributylammonium tetrapentafluorophenylboron, N,N-diethylanilinium tetraphenylboron, N,N-diethylanilinium tetrapentafluorophenylboron, diethylammonium tetrapentafluorophenylboron, triphenylphosphonium tetraphenylboron, trimethylphosphonium tetraphenylboron, triethylammonium tetraphenylaluminum, tributylammonium tetraphenylaluminum, trimethylammonium tetraphenylaluminum, tripropylammonium tetraphenylaluminum, trimethylammonium tetra(p-tolyl)aluminum, tripropylammonium tetra(p-tolyl)aluminum, triethylammonium tetra(o,p-dimethylphenyl)aluminum, tributylammonium tetra(p-trifluoromethylphenyl)aluminum, trimethylammonium tetra(p-trifluoromethylphenyl)aluminum, tributylammonium tetrapentafluorophenylaluminum, N,N-diethylanilinium tetraphenylaluminum, N,N-diethylanilinium tetrapentafluorophenylaluminum, diethylammonium tetrapentatetraphenylaluminum, triphenylphosphonium tetraphenylaluminum, trimethylphosphonium tetraphenylaluminum, tripropylammonium tetra(p-tolyl) boron, triethylammonium tetra(o,p-dimethylphenyl)boron, triphenylcarbonium tetra(p-trifluoromethylphenyl)boron, triphenylcarbonium tetrapentafluorophenylboron, and the like.

In a specific example, the hybrid metallocene catalyst for olefin polymerization may further include a carrier which supports the hybrid transition metal compound, the cocatalyst compound, or both.

Herein, the carrier may include a material containing a hydroxyl group on the surface, and preferably, may use a material having highly reactive hydroxyl and siloxane groups, which is dried to remove moisture from the surface. For example, the carrier may include at least one selected from the group consisting of silica, alumina, and magnesia. Specifically, silica, silica-alumina, silica-magnesia, and the like which are dried at a high temperature may be used as the carrier, and these may usually contain oxide, carbonate, sulfate, and nitrate components such as Na₂O, K₂CO₃, BaSO₄, and Mg(NO₃)₂. In addition, these may include carbon, zeolite, magnesium chloride, and the like. However, the carrier is not particularly limited thereto.

The carrier may have an average particle size of 10 to 250 μm, preferably 10 to 150 μm, and more preferably 20 to 100 μm.

The carrier may have a micropore volume of 0.1 to 10 m1/g, preferably 0.5 to 5 m1/g, and more preferably 1.0 to 3.0 m1/g.

The carrier may have a specific surface area of 1 to 1,000 m²/g, preferably 100 to 800 m²/g, and more preferably 200 to 600 m²/g.

In a preferred example, when the carrier is silica, a drying temperature of silica may be 200 to 900° C. The drying temperature may be preferably 300 to 800° C., and more preferably 400 to 700° C. When the drying temperature is lower than 200° C., silica has too much moisture so that the moisture on the surface reacts with a first cocatalyst compound, and when the drying temperature is higher than 900° C., the structure of the carrier may collapse.

A concentration of a hydroxyl group in dried silica may be 0.1 to 5 mmol/g, preferably 0.7 to 4 mmol/g, and more preferably 1.0 to 2 mmol/g. When the concentration of the hydroxyl group is less than 0.1 mmol/g, the supported amount of the cocatalyst is lowered, and when the concentration is more than 5 mmol/g, the catalyst component becomes inactive.

The total amount of the hybrid transition metal compound supported on the carrier may be 0.001 to 1 mmol based on 1 g of the carrier. When a ratio between the hybrid transition metal compound and the carrier satisfies the above range, appropriate supported catalyst activity is shown, which is advantageous in terms of the activity maintenance and economic feasibility of a catalyst.

The total amount of the cocatalyst compound supported on the carrier may be 2 to 15 mmol based on 1 g of the carrier. When the ratio of the cocatalyst compound and the carrier satisfies the above range, it is advantageous in terms of the activity maintenance and economic feasibility of a catalyst.

One or two or more carriers may be used. For example, both the hybrid transition metal compound and the cocatalyst compound may be supported on one carrier, and each of the hybrid transition metal compound and the cocatalyst compound may be supported on two or more carriers. In addition, only one of the hybrid transition metal compound and the cocatalyst compound may be supported on the carrier.

### Olefin-Based Polymer

An olefin-based monomer is polymerized in the presence of the catalyst for olefin polymerization according to an exemplary embodiment of the present invention, thereby preparing an olefin-based polymer.

According to another exemplary embodiment of the present invention, an olefin-based polymer which is polymerized in the presence of the hybrid metallocene catalyst for olefin polymerization, and has a density of 0.940 to 0.960 g/cm³, a melt index (I_{2.16}) measured with a load of 2.16 kg at 190° C. of 0.02 to 2.0 g/10 min, a ratio (melt flow ratio; MFR) between a melt index (I_{21.6}) measured with a load of 21.6 kg and a melt index (I_{2.16}) measured with a load of 2.16 kg at 190° C. of 30 to 200, and a processability index represented by the following Equation 1 of 0 to 4.5, preferably 0 to 4.0 is provided:

$$Processability index = [ ( HMW \% ) \times ( HMW Mw ) - ( LMW \% ) \times ( LMW Mw ) ] \times ( total PDI ) / ( total Mw ) \qquad [ Equation 1 ]$$

wherein HMW %, LMW %, HMW Mw, LMW Mw, total PDI, and total Mw are as defined for the above hybrid metallocene catalyst.

The olefin-based polymer prepared in the presence of the hybrid metallocene catalyst for olefin polymerization according to an exemplary embodiment of the present invention has a density of 0.940 to 0.960 g/cm³. Preferably, the olefin-based polymer may have a density of 0.945 to 0.955 g/cm³, more preferably 0.945 to 0.950 g/cm³.

The olefin-based polymer prepared in the presence of the hybrid metallocene catalyst for olefin polymerization according to an exemplary embodiment of the present invention may have a melt index (I_{2.16}) measured with a load of 2.16 kg at 190° C. in accordance with ASTM D 1238 of 0.02 to 2.0 g/10 min. Preferably, the olefin-based polymer may have a melt index (I_{2.16}) of 0.05 to 1.5 g/10 min, more preferably 0.05 to 1.0 g/10 min.

The olefin-based polymer prepared in the presence of the hybrid metallocene catalyst for olefin polymerization according to an exemplary embodiment of the present invention may have a ratio between a melt index (I_{21.6}) measured with a load of 21.6 kg and a melt index (I_{2.16}) measured with a load of 2.16 kg at 190° C. in accordance with ASTM D 1238 of 30 to 200. Preferably, the olefin-based polymer may have an MFR of 50 to 150, more preferably 50 to 135.

The olefin-based polymer prepared in the presence of the hybrid metallocene catalyst for olefin polymerization according to an exemplary embodiment of the present invention has a processability index represented by Equation 1 of 0 to 4.5. Preferably, the olefin-based polymer has a processability index of 0 to 4.0.

In a specific example of the present invention, in the olefin-based polymer, an area of a low molecular weight polymer having a weight average molecular weight of 5,000 to 30,000 g/mol may be 40 to 85%, and an area of a high molecular weight polymer having a weight average molecular weight of 50,000 to 600,000 g/mol may be 15 to 60%, when measured with GPC.

In a specific example of the present invention, the olefin-based polymer may have a shear rate as defined in the following Equation 2 of 1,750 sec-1 or more, preferably 2,0000 sec⁻¹ or more, when measured with a capillary rheometer: A higher shear rate is preferred, but substantially, the upper limit may be 3,500 sec⁻¹.

$${\dot{γ}}_{ap} = \frac{4 V}{π {R}^{3}} \qquad [ Equation 2 ]$$

wherein \dot{Y}ₐᵥ is an apparent shear rate (sec⁻¹), V is a volume flow (m³/sec) produced by a piston, and R is a radius (mm) of a round hole capillary. The shear rate of Equation 2 is a measure of high-speed processability, and as the value is higher, the high-speed processability is better.

In a specific example of the present invention, the olefin-based polymer may be a homopolymer of an olefin-based monomer or a copolymer of olefin-based monomer and comonomer.

The olefin-based monomer is at least one selected from the group consisting of α-olefin having 2 to 20 carbon atoms, diolefin having 1 to 20 carbon atoms, cycloolefin having 3 to 20 carbon atoms, and cyclodiolefin having 3 to 20 carbon atoms.

For example, the olefin-based monomer may be ethylene, propylene, 1-butene, 1-pentene, 4-methyl-1-pentene, 1-hexene, 1-heptene, 1-octene, 1-decene, 1-undecene, 1-dodecene, 1-tetradecene, 1-hexadecene, or the like and the olefin-based polymer may be a homopolymer including only one of the olefin-based monomers exemplified above or a copolymer including two or more thereof.

In an illustrative example, the olefin-based polymer may be a copolymer in which ethylene and C₃₋₂₀ α-olefin are copolymerized, and a copolymer in which ethylene and 1-hexene are copolymerized is preferred, but is not limited thereto.

In this case, the content of ethylene is preferably 55 to 99.9 wt %, and more preferably 90 to 99.9 wt %. The content of the α-olefin-based comonomer preferably 0.1 to 45 wt %, and more preferably 0.1 to 30 wt %.

In an illustrative example, the olefin-based polymer may be polymerized by a polymerization reaction such as free radical, cationic, coordination, condensation, and addition polymerization, but is not limited thereto.

In a preferred specific example, the olefin-based polymer may be prepared by a gas phase polymerization method, a solution polymerization method, a slurry polymerization method, or the like. When the olefin-based polymer is prepared by a solution polymerization method or a slurry polymerization method, an example of the solvent to be used may include a C₅₋₁₂ aliphatic hydrocarbon solvent such as pentane, hexane, heptane, nonane, decane, and isomers thereof; an aromatic hydrocarbon solvent such as toluene and benzene; a hydrocarbon solvent substituted by a chlorine atom such as dichloromethane and chlorobenzene; and a mixture thereof, but is not limited thereto.

### BEST MODE FOR CARRYING OUT THE INVENTION

### Examples

Hereinafter, the present invention will be described in more detail through the examples and the comparative examples. However, the following examples are only illustrative of the present invention, and do not limit the scope of the present invention.

### Preparation Example 1

1.4 g of the transition metal compound of Chemical Formula 1-1, 0.63 g of the transition metal compound of Chemical Formula 3-1, and 2.72 g of the transition metal compound of Chemical Formula 4-1 were mixed with 825 g of a toluene solution of 10 wt % of methylaluminoxane (MAO) (Al/Zr=150) in a glove box and stirred at room temperature for 1 hour. Meanwhile, 200 g of silica (XP2402) was added to a reactor, and 1,000 ml of purified toluene was added and mixed. The solution of the transition metal compound was injected into the obtained silica slurry and stirring was performed for 3 hours in an oil bath at 75° C. After completion of supporting and sufficient separation of solid/liquid, a supernatant was removed. The supported catalyst was washed 3 times using toluene, and drying was performed in vacuum at 60° C. for 10 hours to obtain 280 g of a hybrid supported catalyst in a free flow powder form.

### Preparation Example 2

280 g of a hybrid supported catalyst in a free flow powder form was obtained in the same manner as in Preparation Example 1, except that 1.4 g of the transition metal compound of Chemical Formula 1-3, 0.63 g of the transition metal compound of Chemical Formula 3-1, and 2.72 g of the transition metal compound of Chemical Formula 4-1 were used.

### Preparation Example 3

280 g of a hybrid supported catalyst in a free flow powder form was obtained in the same manner as in Preparation Example 1, except that 1.6 g of the transition metal compound of Chemical Formula 2-1, 0.63 g of the transition metal compound of Chemical Formula 3-1, and 2.72 g of the transition metal compound of Chemical Formula 4-1 were used.

### Preparation Example 4

280 g of a hybrid supported catalyst in a free flow powder form was obtained in the same manner as in Preparation Example 1, except that 1.3 g of the transition metal compound of Chemical Formula 1-1, 0.63 g of the transition metal compound of Chemical Formula 3-1, and 2.72 g of the transition metal compound of Chemical Formula 5-1 were used.

### Preparation Example 5

280 g of a hybrid supported catalyst in a free flow powder form was obtained in the same manner as in Preparation Example 1, except that 1.5 g of the transition metal compound of Chemical Formula 1-1, 1.25 g of the transition metal compound of Chemical Formula 3-1, and 2.20 g of the transition metal compound of Chemical Formula 4-1 were used.

### Preparation Example 6

280 g of a hybrid supported catalyst in a free flow powder form was obtained in the same manner as in Preparation Example 1, except that 1.5 g of the transition metal compound of Chemical Formula 1-1, 1.30 g of the transition metal compound of Chemical Formula 3-1, and 2.40 g of the transition metal compound of Chemical Formula 5-1 were used.

### Control Example

A polyethylene product for wires (Lotte Chemical 5305) requiring high-speed processability was used.

### Experimental Example

TABLE 1
Ethylene and 1-hexene were copolymerized in a continuous fluidized bed gas phase reactor, using each
supported catalyst obtained in the above exemplary embodiments. Hydrogen was added for adjusting the
molecular weight of the polymer. Polymerization conditions are summarized in the following Table 1:

| | | | | Comparative | Comparative | |
|---|---|---|---|---|---|---|
| Classification | Example 1 | Example 2 | Example 3 | Example 1 | Example 2 | Example 4 |
| Catalyst | Preparation | Preparation | Preparation | Preparation | Preparation | Preparation |
| | Example 1 | Example 2 | Example 3 | Example 4 | Example 5 | Example 6 |
| Polymerization | 90 | 90 | 90 | 90 | 90 | 90 |
| temperature (° C.) | | | | | | |
| Catalyst injection | 2.06 | 5.87 | 5.47 | 3.75 | 1.91 | 2.41 |
| amount (g/h) | | | | | | |
| Hydrogen injection | 7.51 | 14.81 | 13.52 | 11.79 | 10.60 | 4.23 |
| amount (g/h) | | | | | | |
| 1-Hexene injection | 206 | 154 | 147 | 274 | 403 | 200 |
| amount (kg/h) | | | | | | |
| Hydrogen/ethylene | 0.11 | 0.41 | 0.40 | 0.29 | 0.21 | 0.08 |
| concentration ratio (%) | | | | | | |
| 1-Hexene/ethylene | 0.79 | 0.61 | 0.68 | 0.80 | 1.04 | 0.75 |
| concentration ratio (%) | | | | | | |
| Production per hour | 3,924 | 1,402 | 1,433 | 2,265 | 4,805 | 3,652 |
| (kg/h) | | | | | | |

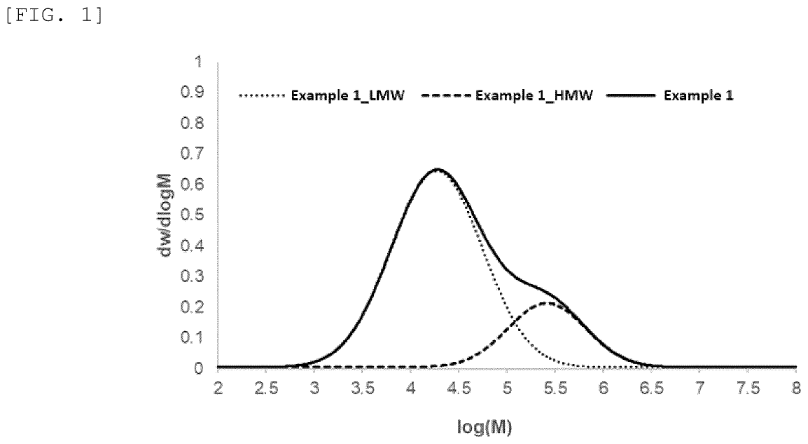

Physical properties of the olefin-based polymers prepared using each supported catalyst obtained in the examples and the comparative examples were measured as follows. The measurement results are shown in the following Tables 2 and 3 and FIG. 1.

### (1) Melt Flow Ratio (MFR)

Each melt index was measured with a load of 21.6 kg and a load of 2.16 kg at 190° C. in accordance with ASTM D 1238, and the ratio (MI_{21.6}/MI_{2.16}) was calculated.

### (2) Density

Measured according to ASTM D 1505.

### (3) Shear Rate

Measured using a Gottfert RG25 capillary rheometer. Measurement conditions were a round hole, a length of 20 mm, an effective length of 20 mm, diameter/width of 2, a height of 0 mm, a run angle of 180° C., and at 230° C., a piston diameter of 15 mm and a capillary diameter of 2 mm. The shear rate was measured based on a sear rate at which shark skin or melt fracture occurs, and calculated from Equation 2.

### (4) Tensile Strength at Yield (Tensile at Yield)

Measured in accordance with ASTM D638. Stress was applied on a No. 4 standard specimen at a speed of 50 mm/min, and a stress section when macroscopic plastic deformation began was measured.

### (5) Gel Transmission Chromatography

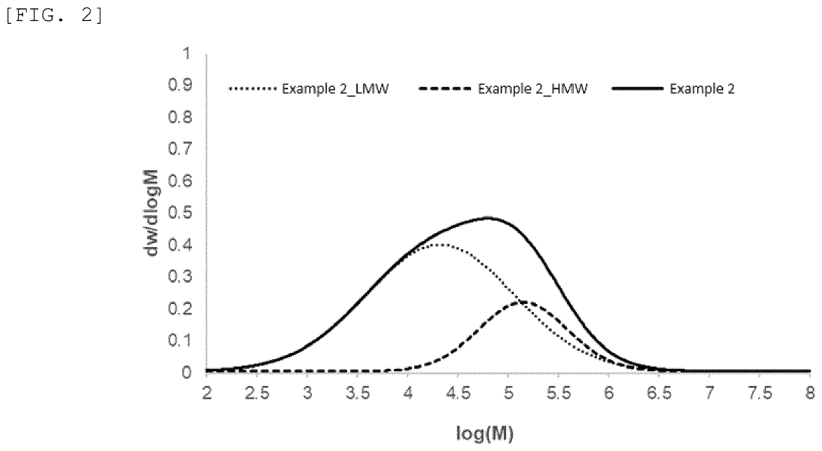

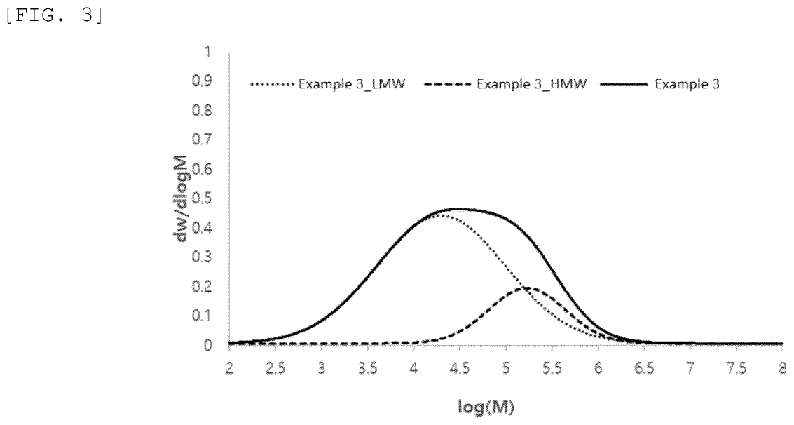

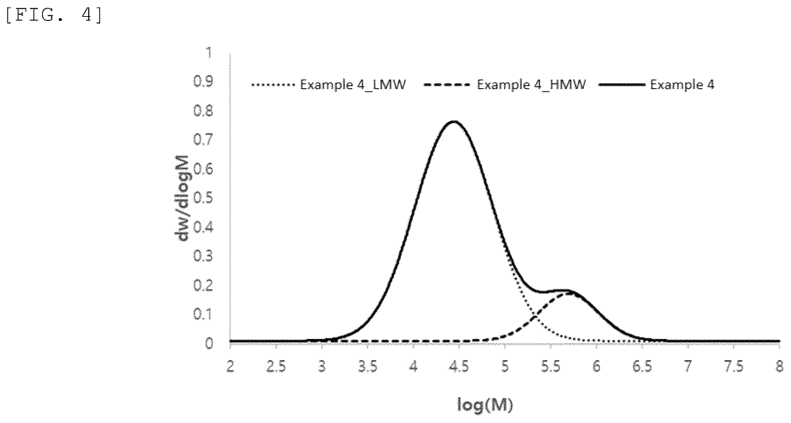

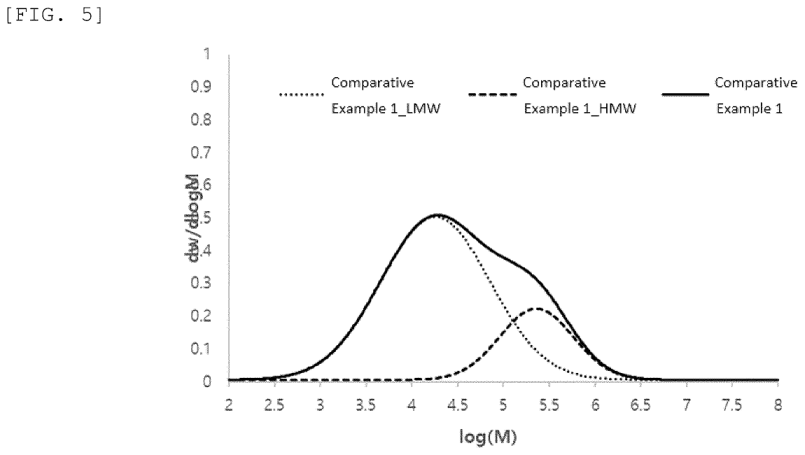

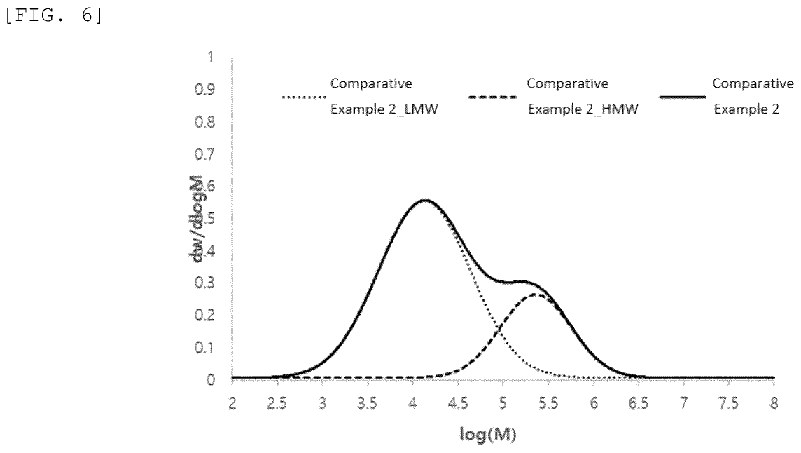

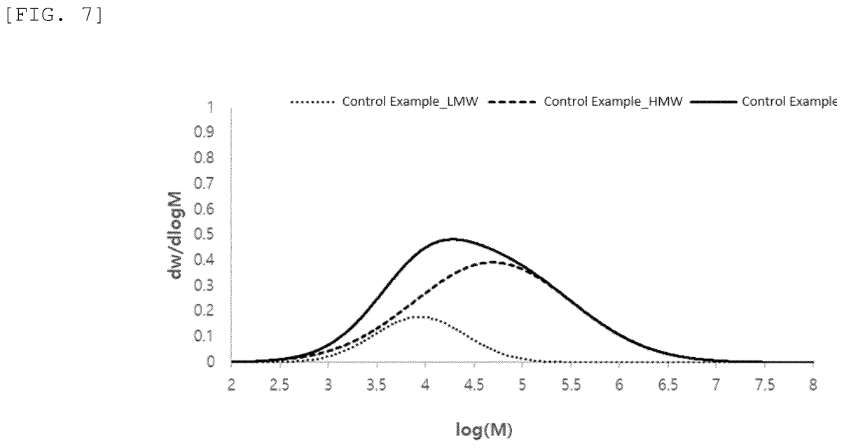

A molecular weight distribution was analyzed using gel transmission chromatography (GPC)-FTIR. In a molecular weight distribution graph obtained from GPC analysis results, low molecular weight (LMW) components and high molecular weight (HMW) components were separated with Mixture Gaussian, and the average molecular weight and the integral ratio of LMW and HMW were calculated. The measurement results are shown in FIGS. 1 to 7.

TABLE 2

| | Examples | Examples | Examples | Comparative | Comparative | Examples | Control |
|---|---|---|---|---|---|---|---|
| Classification | 1 | 2 | 3 | Examples 1 | Examples 2 | 4 | Example |
| I_{2.16} (g/10 min) | 0.74 | 0.65 | 0.79 | 0.66 | 0.82 | 0.67 | 0.74 |
| I_{21.6} (g/10 min) | 75 | 37 | 45 | 43 | 83 | 65 | 49 |
| MFR (I_{2.16}/I_{21.6}) | 101 | 57 | 57 | 65 | 101 | 97 | 65 |
| Density (kg/cm³) | 0.948 | 0.944 | 0.948 | 0.946 | 0.946 | 0.946 | 0.945 |

TABLE 3

| | Tensile | | | CFC (GPC) | | | |
|---|---|---|---|---|---|---|---|
| | strength at | LMW | HMW | Mw | | Processability | Shear rate |
| | yield (kg/cm²) | (g/mol) | (g/mol) | (g/mol) | PDI | index | (1/sec) |
| Example 1 | 265 | 76% | 21% | 121,815 | 12.2 | 4.1 | 1,750 |
| | | 18,725 | 260,166 | | | | |
| Example 2 | 253 | 73% | 24% | 115,548 | 26.0 | 4.0 | 2,000 |
| | | 20,996 | 140,437 | | | | |
| Example 3 | 263 | 76% | 20% | 114,324 | 26.0 | 4.3 | 1,750 |
| | | 19,785 | 168,733 | | | | |
| Comparative | 244 | 74% | 22% | 121,565 | 20.0 | 6.1 | 1,250 |
| Example 1 | | 17,969 | 229,002 | | | | |
| Comparative | 264 | 70% | 25% | 116,840 | 18.8 | 7.7 | 750 |
| Example 2 | | 13,381 | 228,549 | | | | |
| Example 4 | 241 | 81% | 13% | 150,835 | 12.5 | 3.5 | 2,250 |
| | | 27,525 | 494,800 | | | | |
| Control | 226 | 21% | 80% | 173,181 | 22.2 | 4.8 | 1,750 |
| example | | 8,673 | 49,247 | | | | |

As confirmed from Tables 2 and 3, the olefin-based polymers of the examples in which the processability index belonged to the range of the present invention had a high shear rate and excellent high-speed processability. However, the olefin-based polymers of the comparative examples of which the processability index did not belong to the range of the present invention had a low shear rate and poor high-speed processability.

In addition, upon comparison of Example 2 and the control example, the olefin-based polymer of Example 2 secured sufficient mechanical properties only with a lower content of high molecular weight (HMW) component than the high molecular weight (HMW) component of the control example, and also showed better processability index and shear rate (high-speed processability), even with a lower MFR than the olefin-based polymer of the control example.

### INDUSTRIAL APPLICABILITY

The hybrid metallocene catalyst according to an exemplary embodiment of the present invention allows preparation of an olefin polymer having a broad molecular weight distribution and excellent high-speed processability. In addition, an olefin-based polymer prepared in the presence of the catalyst has a broad molecular weight distribution and excellent high-speed processability.

1. A hybrid metallocene catalyst for olefin polymerization comprising: (a) at least one first transition metal compound selected from a transition metal compound represented by the following Chemical Formula 1 and a transition metal compound represented by the following Chemical Formula 2; (b) at least one second transition metal compound selected from a transition metal compound represented by the following Chemical Formula 3; (c) at least one third transition metal compound selected from a transition metal compound represented by the following Chemical Formula 4, a transition metal compound represented by the following Chemical Formula 5a, and a transition metal compound represented by the following Chemical Formula 5b; and (d) a cocatalyst compound, wherein an olefin-based polymer prepared in the presence of the catalyst has a processability index represented by the following Equation 1 of 0 to 4.5: 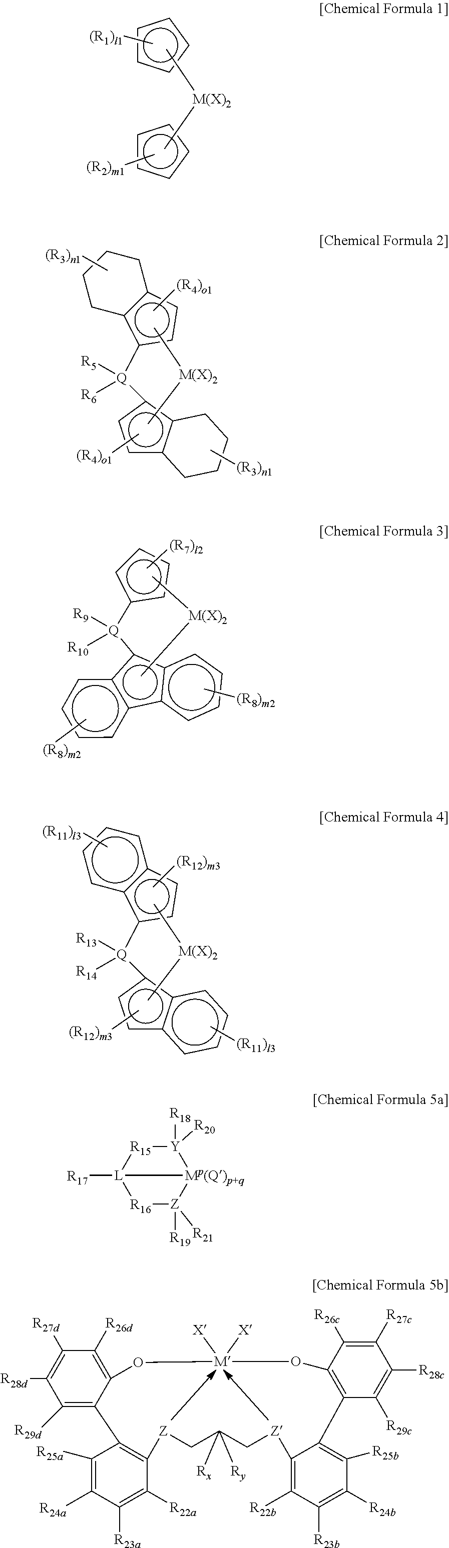
$$Processability index = [ ( HMW \% ) \times ( HMW Mw ) - ( LMW \% ) \times ( LMW Mw ) ] \times ( total PDI ) / ( total Mw ) \qquad [ Equation 1 ]$$
wherein l1 and m1 are independently of each other an integer of 0 to 5,
l2, l3, m2, and n1 are independently of one another an integer of 0 to 4;
m3 and o1 are independently of each other an integer of 0 to 2,
p is an oxidation state of M, and is +3, +4, or +5,
q is a formal charge of a YZL ligand, and is 0, −1, −2, or −3,
M is independently of each other titanium (Ti), zirconium (Zr), or hafnium (Hf),
M′ is titanium, zirconium, or hafnium, and is in a formal oxidation state of +2, +3, or +4, respectively,
X is independently of each other a halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido,
X′ is independently of each other alkyl,
Q is independently of each other carbon (C), silicon (Si), germanium (Ge), or tin (Sn),
Q′ is an anionic leaving group and is independently of each other hydrogen, a substituted or unsubstituted C₁₋₄₀ hydrocarbon group, a substituted or unsubstituted C₁₋₄₀ heterohydrocarbon group, a heteroatom, or a halogen,
L is a Group 15 or Group 16 element,
Y is a Group 15 element,
Z is a Group 15 element,
Z′ is independently of each other —O—, —S—, —N(C₁₋₄₀ hydrocarbon group)-, or —P(C₁₋₄₀ hydrocarbon group)-,
R₁ to R₄, R₇, R₈, R₁₁, and R₁₂ are independently of one another substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, or substituted or unsubstituted C₁₋₂₀ silyl, but these may or may not be independently of each other connected to an adjacent group to form a substituted or unsubstituted, saturated or unsaturated C₄₋₂₀ ring,
R₅, R₆, R₉, R₁₀, R₁₃, and R₁₄ are independently of each other substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, or substituted or unsubstituted C₁₋₂₀ silyl, but R₅ and R₆, R₉ and R₁₀, and R₁₃ and R₁₄ may or may not be independently of one another connected to each other to form a substituted or unsubstituted, saturated or unsaturated C₂₋₂₀ ring,
R₁₅ and R₁₆ are independently of each other a C₁₋₂₀ hydrocarbon group or a heteroatom-containing group, in which the heteroatom is silicon, germanium, tin, lead, or phosphorus, or R₁₅ and R₁₆ may be connected to each other,
R₁₇ does not exist, or is hydrogen, C₁₋₂₀ alkyl, a halogen, or a heteroatom-containing group,
R₁₈ and R₁₉ are independently of each other an alkyl group, an aryl group, a substituted aryl group, a cyclic alkyl group, a substituted cyclic alkyl group, or a polycyclic system,
R₂₀ and R₂₁ independently of each other do not exist, or may be hydrogen, an alkyl group, a halogen, a heteroatom, a hydrocarbon group, or a heteroatom-containing group,
Rₓ and R_{y} are independently of each other a substituted or unsubstituted C₁₋₄₀ hydrocarbon group, a substituted or unsubstituted C₁₋₄₀ heterohydrocarbon group, a halogen, or hydrogen, R₂₂ₐ, R₂₃ₐ, R₂₄ₐ, R₂₅ₐ, R_{22b}, R_{23b}, R_{24b}, R_{25b}, R_{26c}, R_{27c}, R_{28c}, R_{29c}, R_{26d}, R_{27d}, R_{28d}, and R_{29d} are independently of one another a substituted or unsubstituted C₁₋₄₀ hydrocarbon group, a substituted or unsubstituted C₁₋₄₀ heterohydrocarbon group, —Si(Rₑ)₃, —OSi(Rₑ)₃, —Ge(Rₑ)₃, —P(Rₑ)₂, —N(Rₑ)₂, —ORₑ, —SRₑ, —NO₂, —CN, —CF₃, —OCF₃, —S(O)Rₑ, —S(O)₂Rₑ, —N═C(Rₑ)₂, —OC(O)Rₑ, —C(O)ORₑ, —N(R)C(O)Rₑ, —C(O)N(Rₑ)₂, a halogen, and hydrogen, in which Rₑ is independently of each other a substituted or unsubstituted C₁₋₃₀ hydrocarbon group or a substituted or unsubstituted C₁₋₃₀ heterohydrocarbon group, but two or more of R₂₂ₐ, R₂₃ₐ, R₂₄ₐ, R₂₅ₐ, R_{22b}, R_{23b}, R_{24b}, R_{25b}, R_{26c}, R_{27c}, R_{28c}, R_{29c}, R_{26d}, R_{27d}, R_{28d}, and R_{29d} may or may not form one or more cyclic structures, and
HMW % is area % of a high molecular weight polymer in a polymer, LMW % is area % of a low molecular weight polymer in a polymer, HMW Mw is a weight average molecular weight of a high molecular weight polymer in a polymer and is 50,000 to 600,000 g/mol; LMW Mw is a weight average molecular weight of a low molecular weight polymer in a polymer and is 5,000 to 30,000 g/mol; total PDI is a molecular weight distribution (Mn/Mw) of a polymer; and total Mw is a weight average molecular weight of a polymer, when measured with gel permeation chromatography.

2. The hybrid metallocene catalyst for olefin polymerization of claim 1, wherein the olefin-based polymer prepared in the presence of the catalyst has the processability index of 0 to 4.0.

3. The hybrid metallocene catalyst for olefin polymerization of claim 1, wherein the transition metal compound of Chemical Formula 1 is at least one of transition metal compounds represented by the following Chemical Formulae 1-1 to 1-8, and the transition metal compound of Chemical Formula 2 is a transition metal compound represented by the following Chemical Formula 2-1: 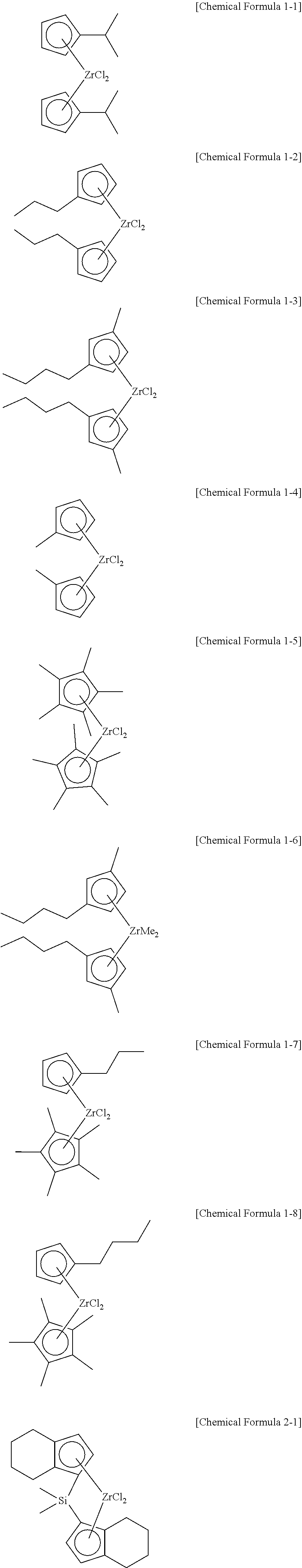
wherein Me is methyl.

4. The hybrid metallocene catalyst for olefin polymerization of claim 1, wherein the transition metal compound of Chemical Formula 3 is at least one of transition metal compounds represented by the following Chemical Formulae 3-1 to 3-10: 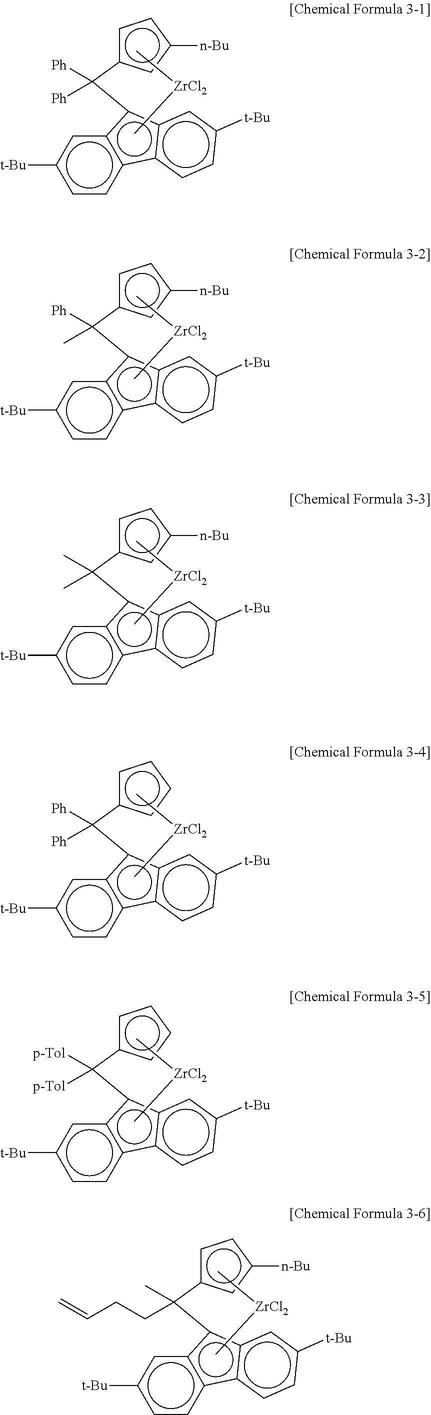 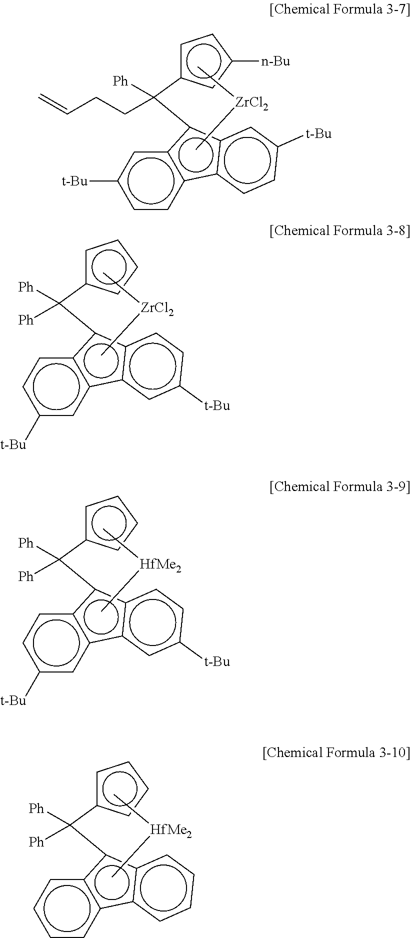
wherein Me is methyl, n-Bu is n-butyl, t-Bu is t-butyl, Ph is phenyl, and p-Tol is p-tolyl.

5. The hybrid metallocene catalyst for olefin polymerization of claim 1, wherein the transition metal compound of Chemical Formula 4 is at least one of transition metal compounds represented by the following Chemical Formulae 4-1 and 4-2, the transition metal compound of Chemical Formula 5a is at least one of transition metal compounds represented by the following Chemical Formulae 5-1 to 5-4, and the compound of Chemical Formula 5b is at least one of transition metal compounds represented by the following Chemical Formulae 5-5 and 5-6: 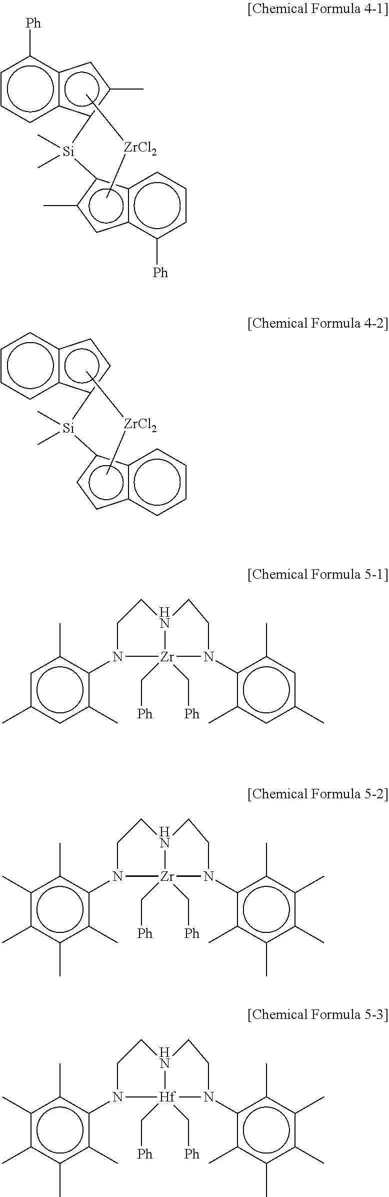 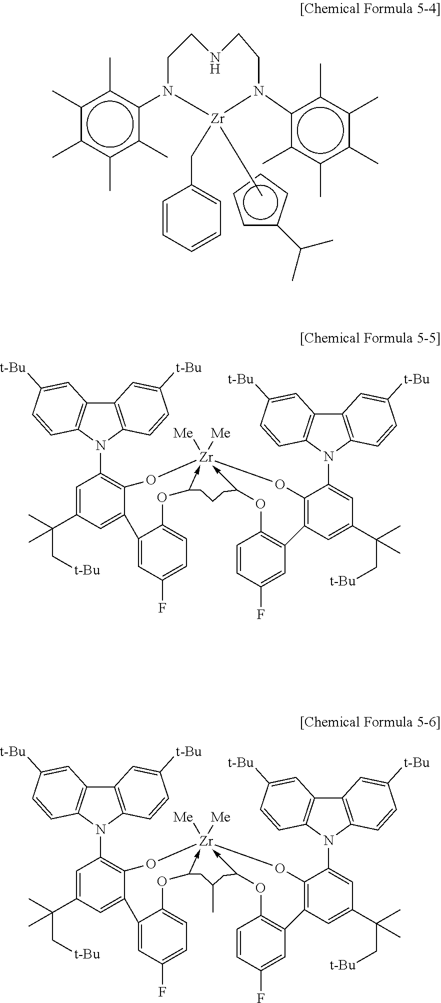
wherein Me is methyl, t-Bu is t-butyl, and Ph is phenyl.

6. The hybrid metallocene catalyst for olefin polymerization of claim 1, wherein the cocatalyst compound includes at least one selected from the group consisting of a compound represented by the following Chemical Formula 6, a compound represented by the following Chemical Formula 7, and a compound represented by Chemical Formula 8: 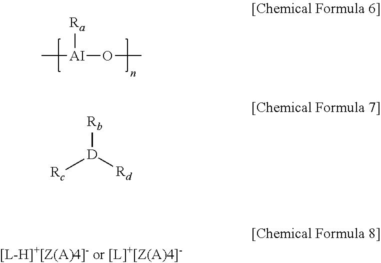
wherein n is an integer of 2 or more, and Rₐ is a halogen atom, a hydrocarbon group having 1 to 20 carbon atoms, or a hydrocarbon group having 1 to 20 carbon atoms substituted by a halogen,
D is aluminum (Al) or boron (B), and R_{b}, R_{c}, and R_{d} are independently of one another a halogen atom, a hydrocarbon group having 1 to 20 carbon atoms, a hydrocarbon group having 1 to 20 carbon atoms substituted by a halogen, or an alkoxy group having 1 to 20 carbon atoms, and
L is a neutral or cationic Lewis base, [L-H]⁺ and [L]⁺ are a Bronsted acid, Z is a Group 13 element, and A is independently of each other a substituted or unsubstituted aryl group having 6 to 20 carbon atoms or a substituted or unsubstituted alkyl group having 1 to 20 carbon atoms.

7. The hybrid metallocene catalyst for olefin polymerization of claim 6, wherein the compound represented by Chemical Formula 6 is at least one selected from the group consisting of methylaluminoxane, ethylaluminoxane, isobutylaluminoxane, and butylaluminoxane.

8. The hybrid metallocene catalyst for olefin polymerization of claim 6, wherein the compound represented by Chemical Formula 7 is at least one selected from the group consisting of trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, and tributylboron.

9. The hybrid metallocene catalyst for olefin polymerization of claim 6, wherein the compound represented by Chemical Formula 8 is at least one selected from the group consisting of triethylammonium tetraphenylboron, tributylammonium tetraphenylboron, trimethylammonium tetraphenylboron, tripropylammonium tetraphenylboron, trimethylammonium tetra(p-tolyl)boron, trimethylammonium tetra(o,p-dimethylphenyl)boron, tributylammonium tetra(p-trifluoromethylphenyl)boron, trimethylammonium tetra(p-trifluoromethylphenyl)boron, tributylammonium tetrapentafluorophenylboron, N,N-diethylanilinium tetraphenylboron, N,N-diethylanilinium tetrapentafluorophenylboron, diethylammonium tetrapentafluorophenylboron, triphenylphosphonium tetraphenylboron, trimethylphosphonium tetraphenylboron, triethylammonium tetraphenylaluminum, tributylammonium tetraphenylaluminum, trimethylammonium tetraphenylaluminum, tripropylammonium tetraphenylaluminum, trimethylammonium tetra(p-tolyl)aluminum, tripropylammonium tetra(p-tolyl)aluminum, triethylammonium tetra(o,p-dimethylphenyl)aluminum, tributylammonium tetra(p-trifluoromethylphenyl)aluminum, trimethylammonium tetra(p-trifluoromethylphenyl)aluminum, tributylammonium tetrapentafluorophenylaluminum, N,N-diethylanilinium tetraphenylaluminum, N,N-diethylanilinium tetrapentafluorophenylaluminum, diethylammonium tetrapentatetraphenylaluminum, triphenylphosphonium tetraphenylaluminum, trimethylphosphonium tetraphenylaluminum, tripropylammonium tetra(p-tolyl)boron, triethylammonium tetra(o,p-dimethylphenyl)boron, triphenylcarbonium tetra(p-trifluoromethylphenyl)boron, and triphenylcarbonium tetrapentafluorophenylboron.

10. The hybrid metallocene catalyst for olefin polymerization of claim 1, further comprising a carrier which supports the hybrid transition metal compound, the cocatalyst compound, or both.

11. The hybrid metallocene catalyst for olefin polymerization of claim 10, wherein the carrier includes at least one selected from the group consisting of silica, alumina, and magnesia.

12. The hybrid metallocene catalyst for olefin polymerization of claim 10, wherein a total amount of the hybrid transition metal compound supported on the carrier is 0.001 to 1 mmol based on 1 g of the carrier, and a total amount of the cocatalyst compound supported on the carrier is 2 to 15 mmol based on 1 g of the carrier.

13. An olefin-based polymer which is polymerized in the presence of the hybrid metallocene catalyst for olefin polymerization claim 1, and has a density of 0.940 to 0.960 g/cm³, a melt index (I_{2.16}) measured with a load of 2.16 kg at 190° C. of 0.02 to 2.0 g/10 min, a ratio (melt flow ratio; MFR) between a melt index (I_{21.6}) measured with a load of 21.6 kg and a melt index (I_{2.16}) measured with a load of 2.16 kg at 190° C. of 30 to 200, and a processability index represented by the following Equation 1 of 0 to 4.5:
$$Processability index = [ ( HMW \% ) \times ( HMW Mw ) - ( LMW \% ) \times ( LMW Mw ) ] \times ( total PDI ) / ( total Mw ) \qquad [ Equation 1 ]$$
wherein HMW %, LMW %, HMW Mw, LMW Mw, total PDI, and total Mw are as defined in claim 1.

14. The olefin-based polymer of claim 13, wherein the processability index is 0 to 4.0.

15. The olefin-based polymer of claim 13, wherein an area of a low molecular weight polymer having a weight average molecular weight of 5,000 to 30,000 g/mol is 40 to 85%, and an area of a high molecular weight polymer having a weight average molecular weight of 50,000 to 600,000 g/mol is 15 to 60%, when measured with GPC.

16. The olefin-based polymer of claim 13, wherein the olefin-based polymer has a shear rate defined by the following Equation 2 of 1,750 sec−¹ or more, when measured with a capillary rheometer:
$${\dot{γ}}_{ap} = \frac{4 V}{π {R}^{3}} \qquad [ Equation 2 ]$$
wherein \dot{Y}ₐᵥ is an apparent shear rate (sec−¹), V is a volume flow (mm³/sec) produced by a piston, and R is a radius (mm) of a round hole capillary.

17. The olefin-based polymer of claim 16, wherein the olefin-based polymer has a shear rate of 2,000 sec−¹ or more.
